(19) United States
(12) Patent Application Publication
(10) Pub. No.: US 2007/0278256 A1
(43) Pub. Date: Dec. 6, 2007

(54) Tamper-evident closure for a container

(76) Inventors: Brian R. Law, Leicester (GB); Robert D. Rohr, LaOtto, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/447,822

(22) Filed: Jun. 6, 2006

(51) Int. Cl. B67D 3/00

(52) U.S. Cl. 222/530

(57) ABSTRACT

A closure for capping a container neck finish by threaded engagement includes a unitary, molded plastic inner cap designed for threaded connection to the neck finish and a unitary, molded plastic outer cap designed for threaded connection to the inner cap. The container neck finish includes an annular series of ratchet teeth positioned below the threaded portion of the neck finish and the inner cap includes a cooperating plurality of ratchet teeth to prevent removal of the inner cap from the neck finish once fully assembled. The inner cap includes an integral pouring spout defined by an inner spout wall and the inner and outer caps cooperate to create a liquid-tight plug seal. A tamper-evident arrangement is provided by the connection of the inner cap and the outer cap, resulting in the fracture of frangible portions as the outer cap is unscrewed from the inner cap to open the container.

### BACKGROUND OF THE INVENTION

The present invention relates in general to container closures for use on larger, molded plastic containers, such as 5-liter containers for vehicle engine lubricants. More specifically, the present invention relates to the design of a multi-component, plastic closure providing a tamper-evident feature. The embodiments disclosed herein include a two-component closure and a three-component closure, excluding as part of the component count any gaskets or seals that may be included. The two-component closure includes an inner cap and an outer cap that are preassembled together before being capped onto the container. The three-component closure begins as a two-component closure with one of the beginning components comprising two portions that are initially connected by frangible elements. However, this particular embodiment of the present invention is constructed and arranged for those frangible elements to break, resulting in two separate components with separate functions.

The components of the various closure embodiments disclosed herein work together in cooperation with a uniquely configured container neck finish to complete the tamper-evident package. Molded plastic containers of the type described herein can be used for a variety of products and would typically include an internally-threaded closing cap that threads onto the externally-threaded container neck finish. Any initial sealing closed of the container neck opening is preferably accomplished by the use of a foil liner that adhesively adheres to the upper (annular) land area of the neck. While this construction is acceptable, there are other closure features that could be introduced as a way to upgrade and improve the overall closure-container combination. For example, one upgrade or improvement would be to incorporate a tamper-evident feature. Another upgrade or improvement would be to incorporate a more user-friendly dispensing feature, such as a pouring spout.

In terms of the addition of a tamper-evident feature or capability, this needs to be considered in the context of the likely or possible contents for the container. If a vehicle engine lubricant, antifreeze, or other vehicle additive is contained in the container, it is important to know that there has not been a tampering attempt, in view of the harm that can be done to the vehicle. Whether due to contamination or due to a substitution of additives for the container contents, if the “wrong” additive is introduced into the vehicle, significant damage can result.

In terms of the addition of a dispensing feature, this needs to be considered in the context of pouring the container contents into some opening or compartment in the vehicle. By providing a pouring spout, the container becomes more user friendly and more easily manipulated for dispensing. This is important due to the anticipated larger size of the container to be used with the closures disclosed herein. For example, a 5-liter container will have substantial weight when filled with a fluid such as a vehicle engine lubricant. The presence of some type of pouring or dispensing spout may also preclude the need for any separate component, such as a funnel, when the container contents are added to the vehicle.

The multi-component closures disclosed herein provide both of these improvements in various embodiments, each in cooperation with the neck finish of the container. The result is an improved closure structure and method for dispensing a fluid, such as oil, from a larger container. Each embodiment is considered to be novel and unobvious in view of the structures, the cooperative relationships, and the specific features provided as part of each component.

### BRIEF SUMMARY OF THE INVENTION

A closure for capping a container neck finish according to one embodiment of the present invention comprises an inner cap constructed and arranged for threaded connection to the neck finish, an outer cap construction and arranged for threaded connection to the inner cap, wherein the neck finish includes a plurality of ratchet teeth and the inner cap includes a cooperating plurality of ratchet teeth, wherein the inner cap further includes a pouring spout defined by an inner spout wall, wherein the outer cap includes an annular inner wall that is constructed and arranged to create a plug seal in cooperation with an annular surface of the inner cap and tamper-evident means for providing a visual indication of removal of the outer cap from the inner cap by leaving a disconnected portion of the outer cap connected to the inner cap.

One object of the present invention is to provide an improved closure for a container neck finish.

Related objects and advantages of the present invention will be apparent from the following description.

### BRIEF DESCRIPTION OF THE SEVERAL VIEWS OF THE DRAWINGS

FIG. 1 is a perspective view of a container and closure combination according to a typical embodiment of the present invention.

FIG. 2 is an exploded view of the FIG. 1 container and closure combination prior to assembly of the two closure components.

FIG. 3 is an exploded, perspective view of the two closure components of FIG. 2.

FIG. 4 is a perspective view, in partial section, of the FIG. 1 container and closure combination.

FIG. 4A is a partial, perspective view, in partial section, of an alternative sealing structure for the FIG. 1 container and closure combination.

FIG. 5 is a perspective view of an inner closure component retained on the container neck finish with the outer closure component removed.

FIG. 6 is a perspective view, in partial section, of a container and closure combination according to another embodiment of the present invention.

FIG. 7 is a partial, perspective view of the FIG. 6 combination with a pouring spout extended.

FIG. 8 is a perspective view, in partial section, of the FIG. 7 pouring spout with the outer closure component removed from the extended pouring spout.

FIG. 9 is a perspective view, in partial section, of a container and closure combination according to another embodiment of the present invention.

FIG. 10 is a partial, perspective view of the FIG. 9 container and closure combinations.

FIG. 11 is a partial, perspective view of the FIG. 9 container and closure combination with an inner closure component extended.

FIG. 12 is a perspective view, in partial section, of the FIG. 11 illustration with the closing cap removed from the extended pouring spout.

### DETAILED DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

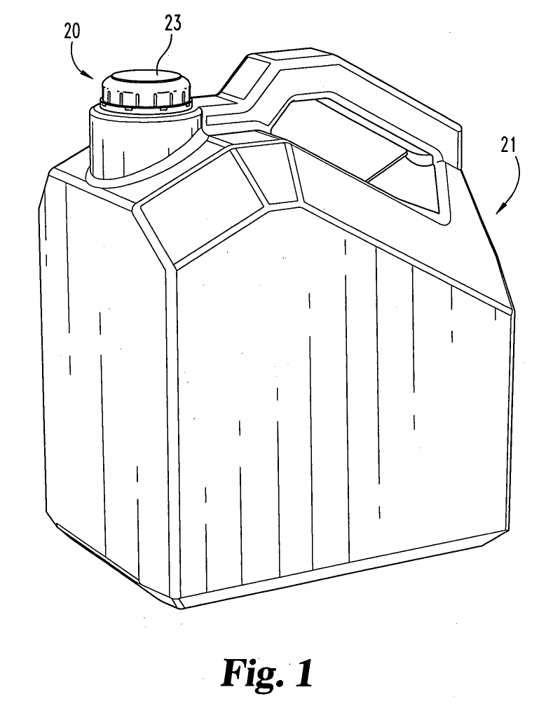

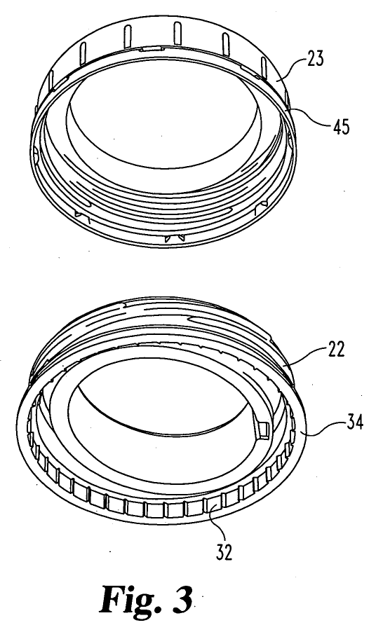

Referring to FIGS. 1-5, there is illustrated a two-component closure 20 for threaded assembly to a container 21. In this illustrated embodiment, container 21 is a molded plastic, 5-liter container, used for motor oil. Alternatives are contemplated in terms of the container size and the intended contents, such as antifreeze and chemical additives for vehicle engines. The two components comprising closure 20 include a unitary, molded plastic inner cap 22 and a unitary, molded plastic outer cap 23.

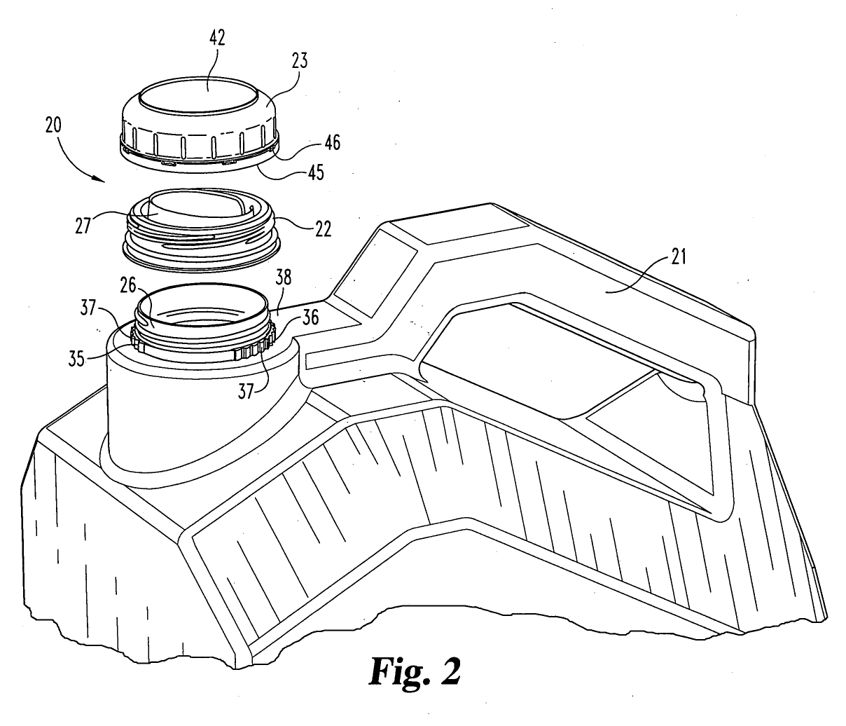

The inner cap 22 is constructed and arranged with a series of walls, shelf portions, and structural forms that cooperate with the threaded neck 26 of container 21 and with the outer cap 23. These walls, shelf portions, and structural forms include inner spout wall 27, outer threaded wall 28, intermediate wall 29, lower shelf portion 30, upper shelf portion 31, offset ratchet wall 32, shelf portion 33, and shelf portion 34. Shelf portions 33 and 34 are axially spaced apart so as to define an annular space therebetween. As illustrated, these various parts of the inner cap are annular in form and cooperate to form the unitary construction of the inner cap. Outer wall 28 includes internal threads 28a and external threads 28b. The internal threads 28a are used for the threaded connection (assembly) of the inner cap 22 to the container neck 26. The external threads 28b are used to connect together the inner and outer caps, 22 and 23, respectively, into an assembled unit. The raised or upwardly extending threaded neck 26 of container 21 includes two spaced-apart series 35 and 36 of ratchet teeth 37 located at the base of neck 26 where it transitions into planar surface 38 of the molded container 21 (see FIG. 2). Included as part of inner spout wall 27 is a removable diaphragm 39. A couple of options for the removal of the diaphragm 39 include cutting out the diaphragm or alternatively defining its outer periphery with a weakened score line and providing a connected tear-out ring (not illustrated).

The outer cap 23 includes an upper panel 42, an inner wall 43, an outer wall 44, and a lower, tamper-evident, frangible band or ring 45 that is connected to the outer wall 44 by a series of spaced-apart, weakened portions or sections referred to herein as frangible elements or portions 46.

As described and illustrated in FIG. 2, the inner cap 22 and outer cap 23 are first threaded together into a unit and then applied, as a preassembled unit, to container neck 26. The assembled combination of the two caps 22 and 23 results in positioning inner wall 43 between spout wall 27 and intermediate wall 29. Internal threads 28a are threaded onto neck 26 such that shelf portion 33 is located beneath outer wall 44 and above the two series 35 and 36 of ratchet teeth 37. Ratchet wall 32 cooperates with series 35 and 36 while shelf portion 34 is located beneath the frangible ring 45.

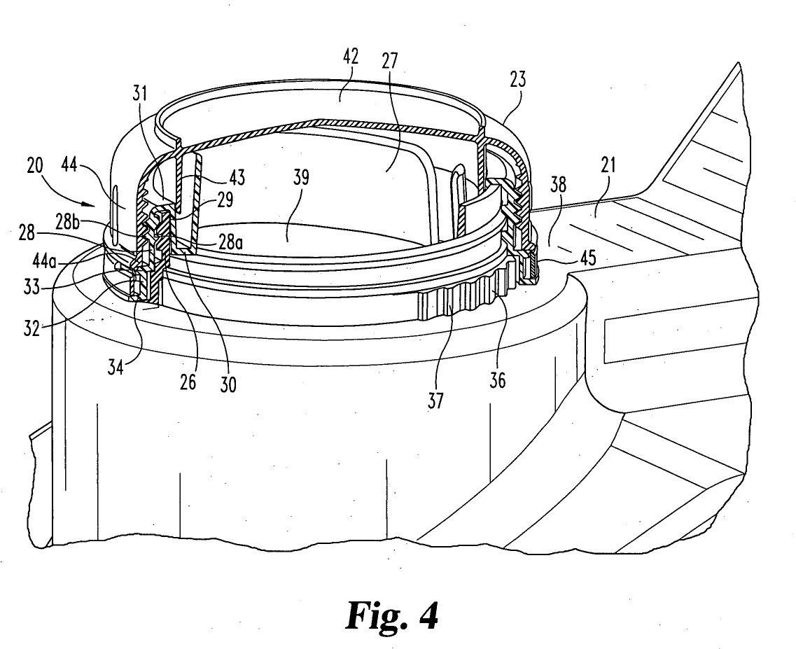

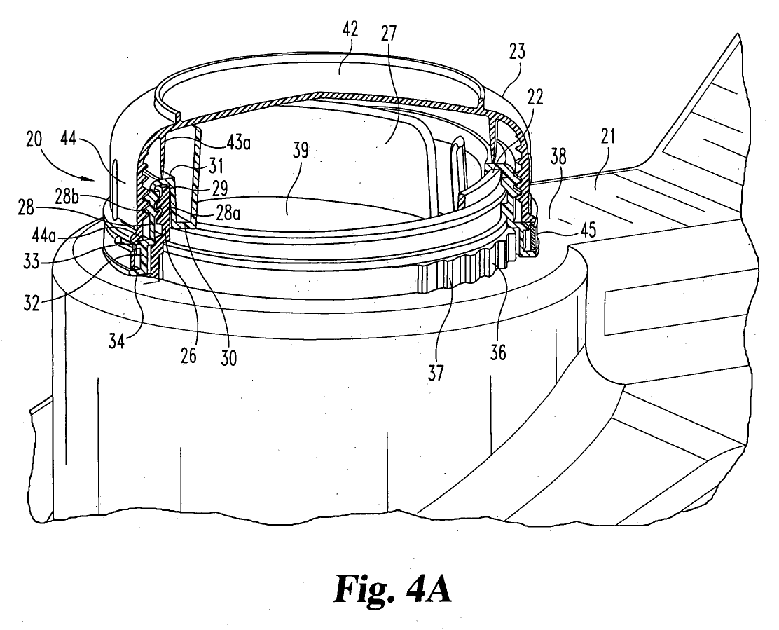

A couple of sealing options are contemplated for the present invention, including a plug-type seal between inner cap 22 and the outer cap 23 as part of their secure fit into a preassembled unit. Another seal option is to incorporate a V-groove seal, see FIG. 4A, wherein the tip of wall 43a seals against a land portion that is provided by shelf portion 31. Forcing the tip of wall 43a against shelf portion 31 creates an axial compression seal. The upper planar surface of shelf portion 31 is substantially perpendicular to the axis of the threaded neck 26 while wall 43a is substantially parallel to the axis of threaded neck 26. As the outer cap 23 is threaded onto the inner cap 22, the lower annular portion 44a of outer wall 44 abuts up against annular shelf portion 33. Shelf portion 33 is directly above (axially) the series of ratchet teeth positioned around the inside surface of offset ratchet wall 32. This abutment prevents an over torque condition of the sealing means and allows the outer cap 23 to actually drive the inner cap 22 onto the neck 26 of container 21. It is further contemplated as part of the disclosed structure that the abutting surfaces (shelf portion 33 and annular portion 44a) may be configured with cooperating drive lugs to facilitate the driving action of the inner cap 22 onto the neck 26 by way of the outer cap 23.

Assembly of the inner cap 22 and outer cap 23 as a unit onto neck 26 begins by aligning the annular space between outer threaded wall 28 and intermediate wall 29 with the axially extending upper threaded portion of neck 26. Threaded engagement follows and, as the closure 20 is driven onto neck 26, cooperatively using the ratchet tooth engagement. This cooperation allows the assembly of closure 20 onto the container neck 26 using conventional capping equipment. The ratchet teeth are designed for application only and do not include any frangible portions that could be used to permit removal. As such, the inner cap 22 is constructed and arranged to remain securely connected or assembled to the container neck 26 after the initial assembly. This is part of the overall design theory for including a pouring spout in the form of pouring spout wall 27 as a unitary portion of inner cap 22. In terms of retaining inner cap 22 on the container neck 26, the pouring spout provided by wall 27 remains a securely connected portion of the overall assembly and remains with the container for use as the container contents are dispensed.

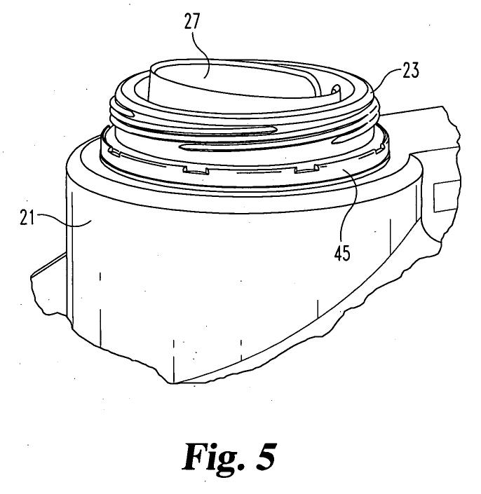

As noted, the outer cap 23 includes a frangible ring 45 that engages the inner cap at or near (axially) the ratchet teeth and offset ratchet wall 32. The frangible ring 45 engages the inner cap 22 with an overlapping undercut such that when the outer cap is applied to the container neck 26, the frangible portions 46 collapse in compression as the undercut of the frangible ring 45 passes over the undercut formed on the inner cap 22. The referenced undercut that is part of the inner cap 22 is located between shelf portion 33 and shelf portion 34, and defined by offset ratchet wall 32. The referenced undercut that is part of outer cap 23 is axially below annular portion 44a and defined by frangible ring 45. During removal of outer cap 23 from inner cap 22, i.e., unthreading, the undercuts engage one another and cause the frangible portions 46 to stretch and ultimately fracture, leaving the frangible ring 45 received by the inner cap 22 while the remainder of outer cap 23 is removed, see FIG. 5. Frangible ring 45 is captured and retained between shelf portion 33 and shelf portion 34.

While the preferred embodiment of closure 20 has been constructed and arranged with the unitary spout portion formed by spout wall 27 as part of inner cap 22, other dispensing options are contemplated as part of the present invention. For example, in lieu of spout wall 27, a pull-out or pull-up spout can be used as a third component as part of the disclosed two-component closure. The pull-out or tear-out diaphragm 39 may be used in combination with the spout wall 27 or may be used without any specific dispensing option in terms of a spout, but rather simply a circular opening. The use of a pull-up dispensing spout can be configured so as to be closed by the outer cap, and would not typically be combined with a tear-out diaphragm.

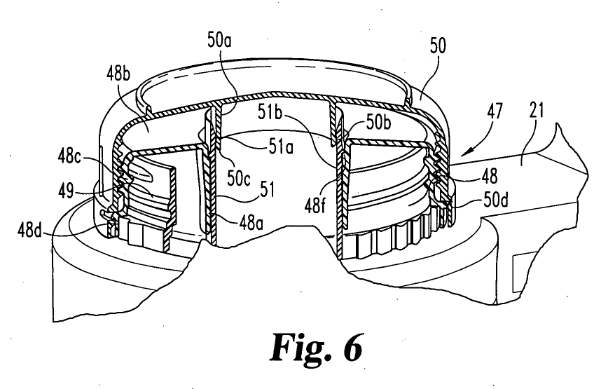

Referring to FIGS. 6, 7, and 8, one dispensing spout variation is disclosed as part of the type of two-component closure 20 that is illustrated in FIGS. 1-5. While closure 47 is not identical to closure 20 in all respects, many of the functional and cooperative relationships between inner cap 48 and container neck 49 are the same as between inner cap 22 and threaded neck 26. Similarly, the threaded connection and interfit of inner cap 48 and outer cap 50 are generally the same as between inner cap 22 and outer cap 23 as illustrated in FIGS. 1-5. The differences between the first embodiment (closure 20) and this second embodiment (closure 47) focus on the addition of pull-up or pull-out (i.e., axially movable) dispensing spout 51. In order to accept or accommodate tubular dispensing spout 51, the inner or interior portion of inner cap 48 is changed from what is illustrated for inner cap 22. A brief visual comparison between the two groups of drawings will reveal the nature and extent of the changes. Most notably, the integral pouring spout (i.e., spout wall 27) is removed and intermediate wall 29 is moved radially inwardly as inner wall 48a. Spout 51 is received within annular inner wall 48a and is axially movable relative to inner wall 48a. Upper shelf portion 31 is now wider as upper wall 48b that is in unitary construction with and extends between inner wall 48a and outer threaded wall 48c. Wall 48c is virtually the same as outer threaded wall 28, including corresponding offset ratchet walls 32 and 48d, respectively. Lower shelf portion 34 does not have a corresponding structure in the embodiment of FIGS. 6-8, detailing closure 47.

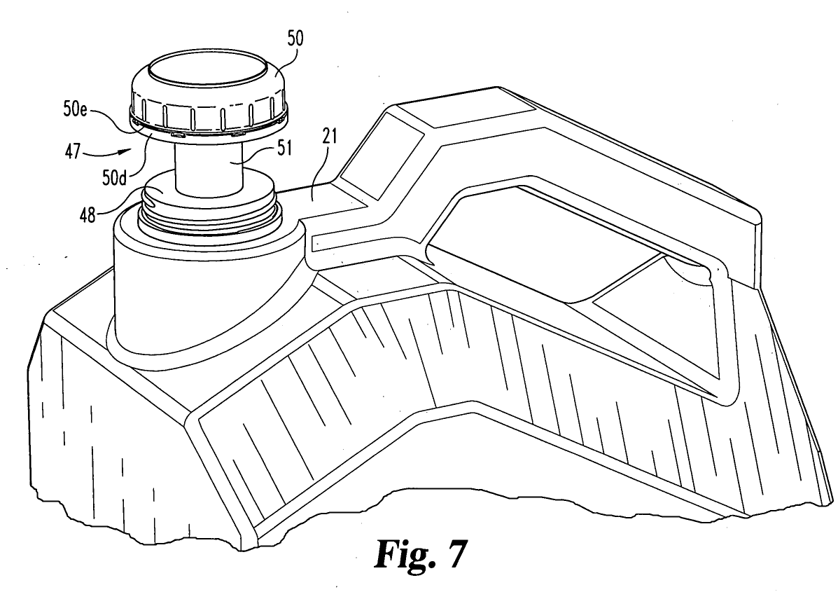

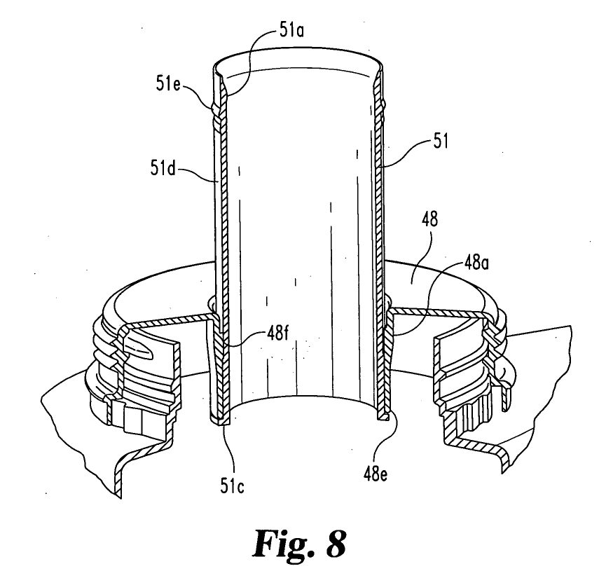

As for any structural differences in the outer cap 50, relative to outer cap 23, inner wall 43 of cap 23 is eliminated, at least as far as its positioning closer to the threaded neck 26 of container 21. In its place, another annular inner wall 50a is used. Inner wall 50a is closer to the axial center of outer cap 50 and is used to snap into spout 51 so that as outer cap 50 is unscrewed from inner cap 48, the spout 51 is pulled up with outer cap 50, see FIG. 7. Thereafter, the outer cap 50 can be pulled free from spout 51 for dispensing of a portion of the contents of the container, see FIG. 8. The snap-fit assembly between the inner wall 50a of outer cap 50 and dispensing spout 51 utilizes a small, radially outwardly raised annular rib 50b at the free end 50c of inner wall 50a and a cooperating raised annular rib 5 la extending radially inwardly as part of the inner surface 51b of spout 51, see FIG. 6.

Spout 51 further includes an annular, radially extending lower shelf 51c that is positioned below the lower edge 48e of inner wall 48a. Slightly below rib 51a, i.e., axially downward from rib 51a, and on the outer surface 51d of spout 51 is a raised, annular lip 51e. Inner wall 48a includes a cooperating inwardly extending annular lip 48f, see FIG. 6. Spout 51 is constructed and arranged for a snug, sliding fit inside of and against the inner surface of inner wall 48a of the inner cap 48. A sliding fit also exists between spout 51 and inner wall 50a, but the degree of frictional interference and the dimensional sizes and tolerances make this connection tighter. In this way, the removal of the outer cap 50 from the inner cap 48 allows the outer cap to pull up on the spout, see FIG. 8. In this extended orientation, the snug fit design for spout 51 within inner wall 48a allows the spout 51 to remain extended while pouring or dispensing contents from the container 21 through spout 51.

In use, starting with container 21 closed (i.e., capped) by closure 47, the first step in dispensing (pouring) a portion of the contents is to grasp and turn outer cap 50 in a counterclockwise direction so as to begin to unscrew the outer cap 50 from its threaded connection with inner cap 48. As this unscrewing occurs, the outer cap 50 remains connected with a friction fit to the dispensing spout 51. Ratchet ring 50d is connected to the remainder of outer cap 50 by a series of spaced-apart frangible portions 50e. The ratchet ring 50d is securely connected to inner cap 48 such that the axial movement of outer cap 50, due to the counterclockwise rotation, causes the frangible portions 50e to fracture, thereby allowing the remainder of outer cap 50 to separate from ratchet ring 50d and ring 50d remains connected to inner cap 48 at its base adjacent the container neck. As the remainder of outer cap 50 is unthreaded from inner cap 48, see FIG. 7, the outer cap 50 remains connected to the dispensing spout 51, pulling it upwardly relative to inner cap 40 until the dispensing spout 51 is fully extended (see FIG. 8). The outer cap 50 is removed from the dispensing spout 51 by simply pulling the outer cap free, utilizing a slightly higher force for separation than the force required to pull dispensing spout 51 upwardly through inner cap 48.

When it is time to close the container, the outer cap 50 is simply seated back on the dispensing spout 51 and lowered axially, pushing the dispensing spout 51 into a recessed or nested condition relative to inner cap 48, at which point outer cap 50 is threaded onto inner cap 48 in a clockwise direction. Continued threaded advancement of outer cap 50 results in the assembled condition illustrated in FIG. 6 when fully seated.

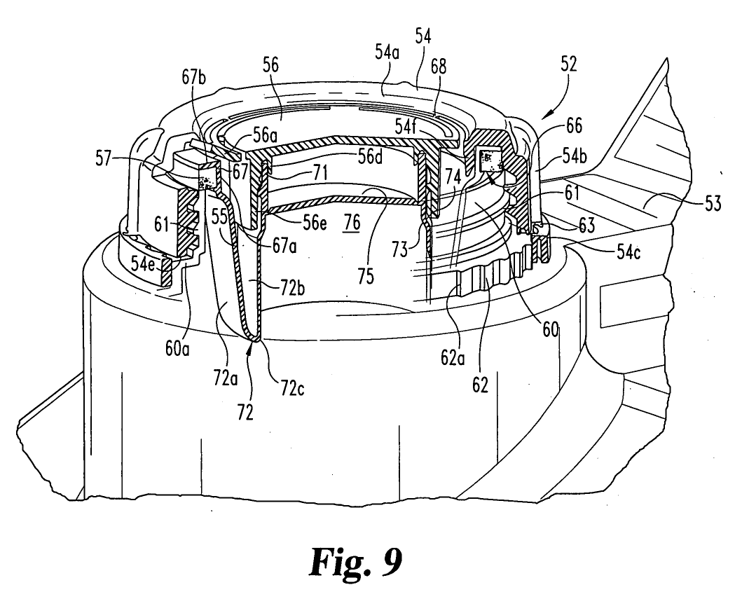

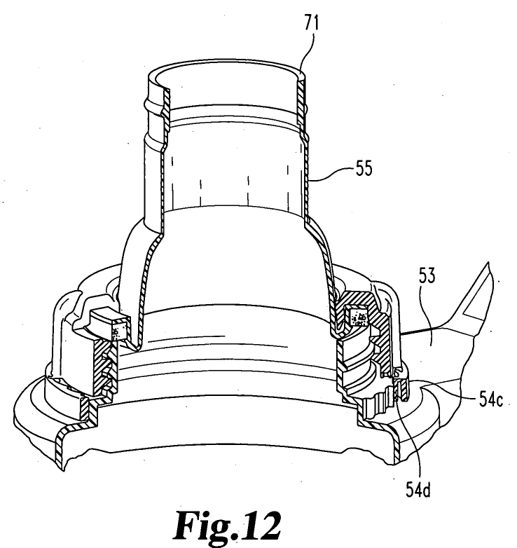

Referring now to FIGS. 9-12, there is illustrated another embodiment of the disclosed device in the form of multi-component closure 52 that is constructed and arranged for threaded connection to a container 53. Closure 52 includes an outer cap 54, an inner, nestable and extendable pouring spout 55, a closing cap 56, and an annular foam gasket 57. The outer cap 54, pouring spout 55, and closing cap 56 are each unitary, molded plastic components.

Outer cap 54 includes an annular upper panel 54a, an annular sidewall 54b, and a lower, outer, annular ratchet ring 54c. The neck 60 of container 53 is externally threaded and located axially below the series of threads 61 is an annular ring 62 of ratchet teeth 62a that are constructed and arranged to cooperate with the ratchets formed as part of ratchet ring 54c. In one embodiment of the disclosed device of FIGS. 9-12, ratchet ring 54c is initially connected to outer cap 54 by a spaced-apart series of frangible elements 63. Upon the initial capping (i.e., closing) of container 53 with closure 52, the outer cap 54 threads onto the threads 61 of neck 60. With continued thread engagement and axial advancement of outer cap 54, the ratchet ring 54c reaches annular ring 62 and the ratchet teeth 54d of ring 54c begin to flex and pass over the ratchet teeth 62a. This ability of the teeth 54d to flex and ramp over teeth 62a is a result of their respective and cooperative shaping and the direction of rotation (clockwise advancing) of the outer cap 54 onto neck 60.

Neck 60 includes a generally horizontal shelf 60a that is located between the base area of neck threads 61 and the annular ring 62 of ratchet teeth 62a. The lower surface 54e of sidewall 54b is drawn into abutment against the upper surface of shelf 60a when the thread engagement is secure and complete. This abutment prevents over tightening of outer cap 54 and the over compression (axially) of foam gasket 57.

Outer cap 54 further includes an annular inner wall 54f that is generally concentric with outer sidewall 54b. These two walls, in cooperation with upper panel 54a, define an inverted U-shaped annular channel 66. Seated within annular channel 66 are a radial flange portion 67 of pouring spout 55 and the foam gasket 57. The radial flange portion 67 includes an annular, vertical sidewall 67a and an integral, annular, horizontal panel 67b. The interfit of flange portion 67, gasket 57, and channel 66 is illustrated in FIG. 9.

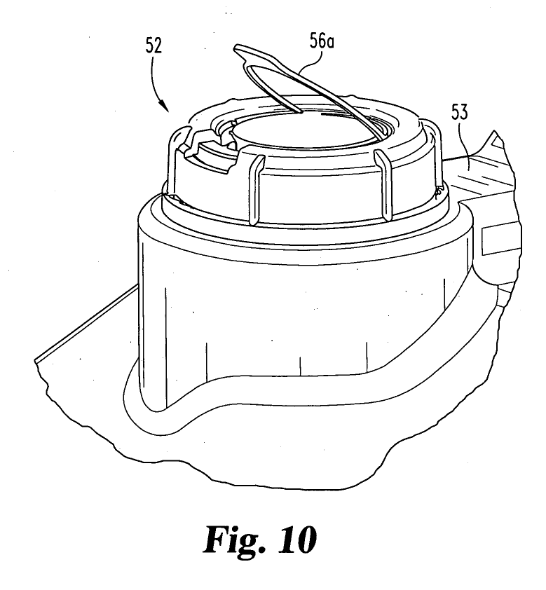

Closing cap 56 includes a lift ring 56a that is integrally hinged to upper panel 56b. The lift ring 56a includes an integral finger tab 56c to enable the user to more easily pull up on and grasp lift ring 56a, see FIG. 10. Initially the lift ring 56a is connected to inner wall 54f by a spaced-apart plurality of frangible elements 68. The actual location of connection for the frangible elements is adjacent the “corner” between inner wall 54f and upper panel 54a.

Closing cap 56 further includes an annular, inner wall 56d and concentric therewith an outer, annular sidewall 56e that is internally-threaded for threaded engagement onto the threaded end of spout 55. Both inner wall 56d and sidewall 56e are axially depending (downwardly) from upper panel 56b, as part of the unitary construction of closing cap 56. In terms of their depending axial dimensions, inner wall 56d is relatively short and is used to sealingly capture upper lip 71 of spout 55. Outer sidewall 56e is longer so that a sufficient number of threads can be provided for the secure engagement and closing of the pouring spout 55.

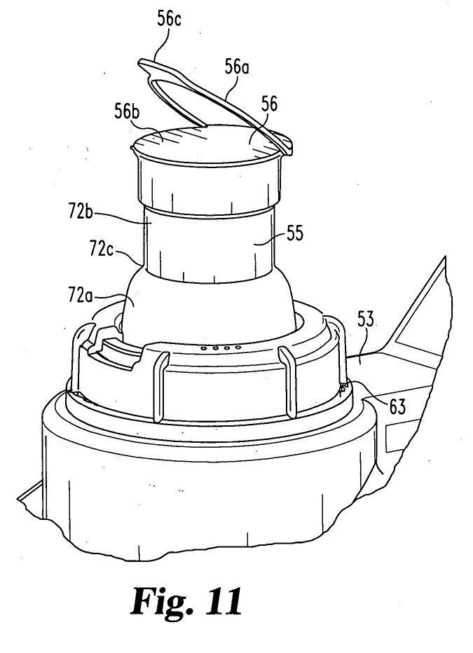

The pouring spout 55 further includes an invertible fold portion 72 including an outer spout wall section 72a, an integral inner spout wall section 72b, and an invertible fold 72c positioned between sections 72a and 72b. With the radial flange portion 67 securely anchored to neck 60 by the tight threaded connection of outer cap 54 to neck 60, pulling up on the nested pouring spout (see FIG. 9) so as to achieve the extended condition of FIG. 11, causes the invertible fold 72c to flip or reverse its orientation.

Pouring spout 55 further includes a generally cylindrical sidewall 73 that is externally-threaded and integral with spout wall section 72b, though radially inset therefrom by angled transition section 74. A tear-out or alternatively cut-out diaphragm 75 is integrally molded as part of spout 55, extending across pour opening 76 that is defined by sidewall 73. Diaphragm 75 provides a way to sealingly close off and protect the contents the container 53 to prevent tampering and/or contamination.

In terms of security and the desirability of providing a tamper-evident capability, the construction and arrangement of closure 52 in cooperation with container 53 provides several of these tamper-evident features or capabilities. First, the use of ratchet ring 54c and ratchet teeth 62a cause the ratchet ring to break free from outer cap 54 by fracturing frangible element 63 when there is an attempt to unscrew and remove outer cap 54 from neck 60. When this attempt is made, the two sets of ratchet teeth abut one another and cause the ratchet ring to remain stationary and fixed in position. Consequently, with continued retrograde movement of the outer cap, there is a resulting structural failure and severing of the connecting frangible elements 63. Any visual inspection revealing that the frangible elements have been severed indicates that there may have been a tampering attempt.

Since the lift ring 56a is connected to inner wall 54e by frangible elements 68, any attempt to either lift up on closing cap 56 to extend spout 55 or simply unscrew closing cap 56 will be revealed upon visual inspection by the fractured or severed status of the frangible elements 68. This structural combination provides a second tamper-evident feature for the disclosed device. The final tamper-evident feature is provided by the tear-out or cut-out diaphragm 75. When diaphragm 75 is constructed and arranged to be torn out, the arrangement includes weakened score lines.

In terms of other design options and alternatives that are contemplated for the closures disclosed herein, it is recognized that an aluminum liner can be used to secure the inner cap 22 to the container neck 26 as configured in FIG. 4. The aluminum liner is positioned between the contacting surfaces of the inner cap 22 and the container neck 26 and this aluminum liner is coated with one of various known chemical compounds that soften upon heating and then fuse the two components together when the coating solidifies. The method steps for using this design option include first adding the liner to the inner cap and then assembling the inner cap to the container neck. The next step is to heat the liner for completing the sealing/bonding of the inner component to the container. The completing step is to assemble the outer cap 23 and complete the closure. This method becomes useful when there is a need or desire to fix the pouring direction of the inner spout wall 27 that is a unitary portion of inner cap 22. Using routine threaded assembly for a specific spout direction provides only an approximation of the desired location, if tight threaded engagement is going to be achieved as would be required for liquid-tight sealing.

Another design option for the disclosed closure is to secure the inner cap to the container by a friction weld. This general method includes such bonding techniques as spin welding and ultrasonic welding. The sequence of steps is basically the same as with the aluminum liner, except that the heating step is replaced with the friction weld step.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1. A closure for capping a container neck finish, said closure comprising:
an inner cap constructed and arranged for connection to said neck finish;
an outer cap constructed and arranged for connection to said inner cap;
wherein said neck finish includes a plurality of ratchet teeth and said inner cap includes a cooperating plurality of ratchet teeth;
wherein said inner cap further includes a pouring spout defined by an inner spout wall;
sealing means for establishing a sealed interface between said outer cap and said inner cap; and
tamper-evident means for providing a visual indication of removal of said outer cap from said inner cap by leaving a disconnected portion of said outer cap received by said inner cap.

2. The closure of claim 1 wherein said sealing means includes an annular wall of said outer cap that is constructed and arranged to create a plug seal in cooperation with an annular surface of said inner cap.

3. The closure of claim 2 wherein said outer cap includes a lower skirt that is constructed and arranged to abut against a ledge that is formed as part of said inner cap, this abutment enabling the outer cap to drive the inner cap onto said neck finish.

4. The closure of claim 3 wherein said outer cap includes an outer wall and said tamper-evident means including a tamper-evident band initially connected to said outer wall by a plurality of frangible portions, said tamper-evident band corresponding to said disconnected portion.

5. The closure of claim 4 wherein said inner cap including axially spaced-apart shelf portions defining an annular space therebetween, said tamper-evident band being received within said annular space.

6. The closure of claim 1 wherein said outer cap includes a lower skirt that is constructed and arranged to abut against a ledge that is formed as part of said inner cap, this abutment enabling the outer cap to drive the inner cap onto said neck finish.

7. The closure of claim 1 wherein said outer cap includes an outer wall and said tamper-evident means including a tamper-evident band initially connected to said outer wall by a plurality of frangible portions, said tamper-evident band corresponding to said disconnected portion.

8. The closure of claim 7 wherein said inner cap including axially spaced-apart shelf portions defining an annular space therebetween, said tamper-evident band being received within said annular space.

9. The closure of claim 1 wherein said sealing means includes an inner annular wall of said outer cap that is constructed and arranged to contact an annular land portion of said inner cap for a compression seal.

10. The closure of claim 9 wherein said outer cap includes a lower skirt that is constructed and arranged to abut against a ledge that is formed as part of said inner cap, this abutment enabling the outer cap to drive the inner cap onto said neck finish.

11. The closure of claim 10 wherein said outer cap includes an outer wall and said tamper-evident means including a tamper-evident band initially connected to said outer wall by a plurality of frangible portions, said tamper-evident band corresponding to said disconnected portion.

12. The closure of claim 11 wherein said inner cap including axially spaced-apart shelf portions defining an annular space therebetween, said tamper-evident band being received within said annular space.

13. A closure for capping a container neck finish, said closure comprising:
an inner cap constructed and arranged for connection to said neck finish;
an outer cap constructed and arranged for connection to said inner cap;
wherein said neck finish includes a plurality of ratchet teeth and said inner cap includes a cooperating plurality of ratchet teeth;
an extendable spout received by said inner cap and being axially movable relative to said inner cap;
wherein said outer cap including an inner annular wall that extends into said extendable spout with an interfit suitable for said extendable spout to move axially as said outer cap moves axially relative to said inner cap; and
tamper-evident means for providing a visual indication of removal of said outer cap from said inner cap by leaving a disconnected portion of said outer cap received by said inner cap.

14. The closure of claim 13 wherein said outer cap includes a lower skirt that is constructed and arranged to abut against a ledge that is formed as part of said inner cap, this abutment enabling the outer cap to drive the inner cap onto said neck finish.

15. The closure of claim 14 wherein said outer cap includes an outer wall and said tamper-evident means including a tamper-evident band initially connected to said outer wall by a plurality of frangible portions, said tamper-evident band corresponding to said disconnected portion.

16. The closure of claim 15 wherein said inner cap including axially spaced-apart shelf portions defining an annular space therebetween, said tamper-evident band being received within said annular space.

17. The closure of claim 13 wherein said outer cap includes an outer wall and said tamper-evident means including a tamper-evident band initially connected to said outer wall by a plurality of frangible portions, said tamper-evident band corresponding to said disconnected portion.

18. The closure of claim 17 wherein said inner cap including axially spaced-apart shelf portions defining an annular space therebetween, said tamper-evident band being received within said annular space.

19. The closure of claim 13 wherein said extendable spout including an inner annular rib for said interfit with said inner annular wall.

20. The closure of claim 19 wherein said extendable spout further including an outer, raised annular lip that is constructed and arranged to cooperate with said inner cap for limiting the axial movement of said extendable spout.

21. A closure for capping a container neck finish, said closure comprising:
an outer cap constructed and arranged for connection to said neck finish, said outer cap defining an annular channel;
a nestable and extendable pouring spout having a radial flange portion positioned within said annular channel;
a closing cap constructed and arranged for connection to said pouring spout; and
tamper-evident means for providing a visual indication of removal of said outer cap from said neck finish by leaving a disconnected portion of said outer cap received by said neck finish.

22. The closure of claim 21 wherein said tamper-evident means includes a series of ratchet teeth and said neck finish includes a series of cooperating ratchet teeth.

23. The closure of claim 22 wherein said outer cap includes a sidewall, a ratchet ring, and a plurality of frangible elements connecting said ratchet ring to said sidewall.
